(19) United States
(12) Patent Application Publication
(10) Pub. No.: US 2026/0043938 A1
(43) Pub. Date: Feb. 12, 2026

(54) METHODOLOGY TO EVALUATE RESERVOIR FRACTURE DENSITY CORRELATION WITH TIME LAPSE WATER SATURATION

(71) Applicant: Saudi Arabian Oil Company, Dhahran (SA)

(72) Inventors: Jibran Ayub, Dhahran (SA); Otto Meza Camargo, Dhahran (SA); Karla Olvera Carranza, Dhahran (SA)

(73) Assignee: Saudi Arabian Oil Company, Dhahran (SA)

(21) Appl. No.: 18/795,548

(22) Filed: Aug. 6, 2024

(51) Int. Cl. G01V 9/02; G01V 5/10; G01V 11/00; G01V 20/00

(52) U.S. Cl. CPC G01V 9/02; G01V 5/102; G01V 11/002; G01V 20/00

(57) ABSTRACT

A time lapse water saturation model for a naturally fractured subsurface reservoir. A fracture model may be generated using a deformation and geomechanical model, and a fracture density index (FDI) is determined from the fracture model using a critical stress analysis. Additionally, a water saturation vs time is determined using from pulsed neutron lifetime (PNL) logs and a corresponding water saturation log. A time lapse water saturation model is determined using a cross-correlation of the fracture density index (FDI) and water saturation.

### BACKGROUND

### Field of the Disclosure

The present disclosure generally relates to extraction of hydrocarbon (for example, oil and gas) resources from hydrocarbon reservoirs. More specifically, embodiments of the disclosure relate to modeling water saturation in hydrocarbon reservoirs.

### Description of the Related Art

The extraction of hydrocarbon resources from reservoirs in rock formations may depend on a variety of factors. Some reservoirs may present particular challenges with respect to extraction of hydrocarbons, especially with regard to reservoir characterization and modeling. Naturally fractured reservoirs may present such challenges. A variety of factors may pose different difficulties in characterization and modeling for the exploitation of naturally fractured reservoirs.

### SUMMARY

Natural fractures are a key element in reservoir characterization, due to their role as fluid-flow pathways, which influence reservoir fluid-flow and dynamic performance during field development. A reliable construction of a fracture density index (FDI) model depends on the integration of several multi-disciplinary and comprehensive inputs such as fracture characterization, a 3D deformation model, a 3D mechanical earth model and fracture modeling processes. In particular, in naturally fractured reservoirs the fluid flow movements such as water encroachments or high water cut ratios represent a significant challenge for integration within field development plans.

In one embodiment, a method for determining a time lapse water saturation in a naturally fractured subsurface reservoir is provided. The method includes forming, using a mechanical earth model, a fracture network model to identify the presence and extent of natural fractures at locations in the subsurface hydrocarbon reservoir, such that the mechanical earth model incorporates the principal stress. The method also includes determining, using the discrete fracture network, a fracture density index (FDI), such that determining the fracture density index (FDI) includes generating a raster map from the discrete fracture network, the raster map representing a fracture density per area. Additionally, the method includes determining a water saturation over time for a well accessing the subsurface reservoir and determining a time lapse water saturation model for the subsurface reservoir using the fracture density index and the water saturation over time.

In some embodiments, determining a water saturation over time for a well accessing the subsurface reservoir includes obtaining a plurality of pulsed neutron lifetime (PNL) logs over a respective plurality of time periods and determining the water saturation from the plurality of PNL logs. In some embodiments, determining a time lapse water saturation model for the subsurface reservoir using the fracture density index and the water saturation over time includes correlating the water saturation over time with fracture density index (FDI). In some embodiments, determining a time lapse water saturation model for the subsurface reservoir using the fracture density index and the water saturation over time includes performing a sequential Gaussian simulation to extrapolate water saturation points within the discrete fracture network. In some embodiments, the method includes validating the time lapse water saturation model by comparing the time lapse water saturation model with a water production measurement associated with the subsurface reservoir. In some embodiments, the method includes identifying a location in the naturally fractured reservoir subsurface using the time lapse water saturation model and drilling a well in a subsurface geological structure at the location in the naturally subsurface fractured reservoir. In some embodiments, the method includes obtaining a plurality of reservoir parameters representing a respectively plurality of properties of a primary naturally fractured reservoir, and determining a mechanical model using the obtained plurality of reservoir parameters.

In another embodiment, a non-transitory computer-readable storage medium having executable code stored thereon for determining a time lapse water saturation in a naturally fractured subsurface reservoir is provided. The executable code has a set of instructions that causes a processor to perform operations that include forming, using a mechanical earth model, a fracture network model to identify the presence and extent of natural fractures at locations in the subsurface hydrocarbon reservoir, such that the mechanical earth model incorporates the principal stress. The operations also include determining, using the discrete fracture network, a fracture density index (FDI), such that determining the fracture density index (FDI) includes generating a raster map from the discrete fracture network, the raster map representing a fracture density per area. Additionally, the operations include determining a water saturation over time for a well accessing the subsurface reservoir and determining a time lapse water saturation model for the subsurface reservoir using the fracture density index and the water saturation over time.

In some embodiments, determining a water saturation over time for a well accessing the subsurface reservoir includes obtaining a plurality of pulsed neutron lifetime (PNL) logs over a respective plurality of time periods and determining the water saturation from the plurality of PNL logs. In some embodiments, determining a time lapse water saturation model for the subsurface reservoir using the fracture density index and the water saturation over time includes correlating the water saturation over time with fracture density index (FDI). In some embodiments, determining a time lapse water saturation model for the subsurface reservoir using the fracture density index and the water saturation over time includes performing a sequential Gaussian simulation to extrapolate water saturation points within the discrete fracture network. In some embodiments, the operations include validating the time lapse water saturation model by comparing the time lapse water saturation model with a water production measurement associated with the subsurface reservoir. In some embodiments, the operations include identifying a location in the naturally fractured reservoir subsurface using the time lapse water saturation model and drilling a well in a subsurface geological structure at the location in the naturally subsurface fractured reservoir. In some embodiments, the operations include obtaining a plurality of reservoir parameters representing a respectively plurality of properties of a primary naturally fractured reservoir, and determining a mechanical model using the obtained plurality of reservoir parameters.

In another embodiment, a system for determining a time lapse water saturation in a naturally fractured subsurface reservoir is provided. The system includes a processor and a non-transitory computer-readable memory accessible by the processor and having executable code stored thereon. The executable code has a set of instructions that cause the processor to perform operations that include forming, using a mechanical earth model, a fracture network model to identify the presence and extent of natural fractures at locations in the subsurface hydrocarbon reservoir, such that the mechanical earth model incorporates the principal stress. The operations also include determining, using the discrete fracture network, a fracture density index (FDI), such that determining the fracture density index (FDI) includes generating a raster map from the discrete fracture network, the raster map representing a fracture density per area. Additionally, the operations include determining a water saturation over time for a well accessing the subsurface reservoir and determining a time lapse water saturation model for the subsurface reservoir using the fracture density index and the water saturation over time.

In some embodiments, determining a water saturation over time for a well accessing the subsurface reservoir includes obtaining a plurality of pulsed neutron lifetime (PNL) logs over a respective plurality of time periods and determining the water saturation from the plurality of PNL logs. In some embodiments, determining a time lapse water saturation model for the subsurface reservoir using the fracture density index and the water saturation over time includes correlating the water saturation over time with fracture density index (FDI). In some embodiments, determining a time lapse water saturation model for the subsurface reservoir using the fracture density index and the water saturation over time includes performing a sequential Gaussian simulation to extrapolate water saturation points within the discrete fracture network. In some embodiments, the operations include validating the time lapse water saturation model by comparing the time lapse water saturation model with a water production measurement associated with the subsurface reservoir. In some embodiments, the operations include identifying a location in the naturally fractured reservoir subsurface using the time lapse water saturation model and drilling a well in a subsurface geological structure at the location in the naturally subsurface fractured reservoir. In some embodiments, the operations include obtaining a plurality of reservoir parameters representing a respectively plurality of properties of a primary naturally fractured reservoir, and determining a mechanical model using the obtained plurality of reservoir parameters.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a process for determining a time lapse water saturation model in accordance with an embodiment of the disclosure;

FIG. 2 depicts the gridding of a 3D mechanical earth model in accordance with an embodiment of the disclosure;

FIG. 3 illustrates a water saturation log and pulsed neutron lifetime (PNL) logs over three time periods in accordance with an embodiment of the disclosure;

FIG. 4A is a diagram illustrating fluid flow paths for hydraulically conductive and non-hydraulically conductive fractures using normal stresses (σ1 and σ3) in accordance with an embodiment of the disclosure;

FIG. 4B is a plot of shear stress vs normal stress and coefficient of friction in accordance with an embodiment of the disclosure;

FIG. 5A depicts a 2D fracture network illustrating main fluid pathways in an area in accordance with an embodiment of the disclosure;

FIG. 5B depicts a line density raster map computed using the 2D fracture network of FIG. 5A as input in accordance with an embodiment of the disclosure;

FIG. 6 depicts the average water saturations from observed wells at a specific time in accordance with an embodiment of the disclosure;

FIG. 7 is a plot 700 of average saturation vs fracture density index (FDI) showing the cross-correlation between the saturation measured at a well point observation and the fracture density index (FDI) in accordance with an embodiment of the disclosure;

FIG. 8A depicts a fracture density (line density raster) map in accordance with an embodiment of the disclosure;

FIG. 8B depicts a time-lapse water saturation model on the same map in accordance with an embodiment of the disclosure;

FIGS. 9A, 9B, and 9C depict various water saturation models for different time lapses during reservoir production in accordance with an embodiment of the disclosure;

FIG. 10A depicts a map of a water saturation model for a first time lapse in accordance with an embodiment of the disclosure;

FIG. 10B depicts cumulative water production over the water saturation model map of FIG. 10A in accordance with an embodiment of the disclosure; and

FIG. 11 depicts a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to systems, methods, and computer-readable for determining a time lapse water saturation model for a naturally fractured subsurface reservoir. A fracture model may be generated using a deformation and geomechanical model, and a fracture density index (FDI) is determined from the fracture model using a critical stress analysis. Additionally, a water saturation vs time is determined using from pulsed neutron lifetime (PNL) logs and a corresponding water saturation log. A time lapse water saturation model is determined using a cross-correlation of the fracture density index (FDI) and water saturation. A distribution model and simulation of water encroachment may also be determined. In some embodiments, the time lapse water saturation model may be calibrated or validated by comparison to a water saturation measurement.

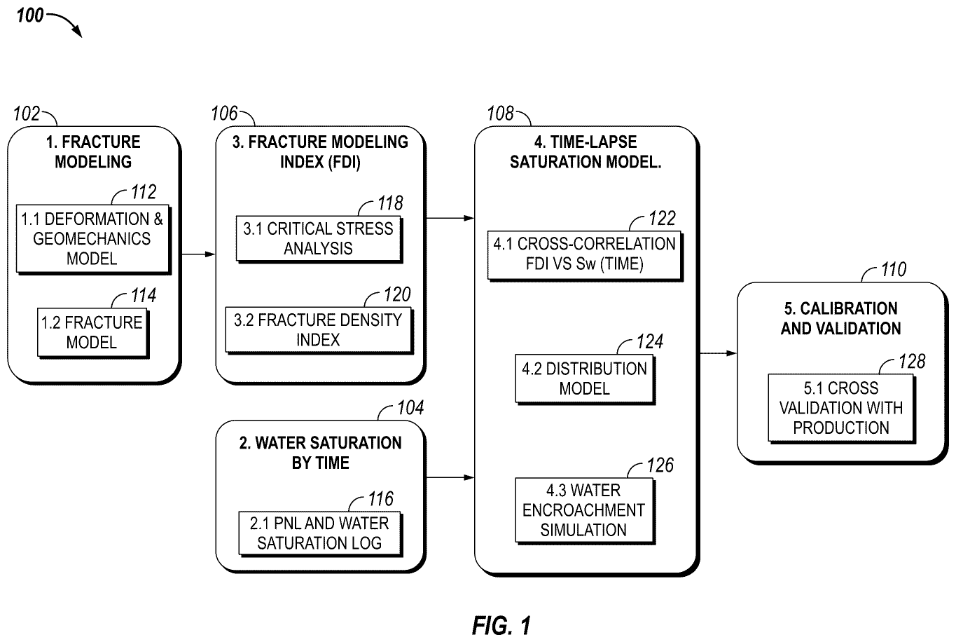

FIG. 1 depicts a process 100 for determining a time lapse water saturation model in accordance with an embodiment of the disclosure. As shown in FIG. 1, the process 100 may include determining a fracture model (block 102), determining a water saturation by time (block 104), determining a fracture density index (FDI) (block 106), determining a time lapse saturation model (block 108), and calibration and validating the time lapse saturation model (block 110).

As shown in FIG. 1, the process 100 may including determining a 3D fracture model (block 102). The 3D fracture model may include a Discrete Fracture Network (DFN) spatial distribution primarily constrained by geomechanical and tectonic drivers. The fracture parameters used to construct the network may be length, orientation, aspect ratio (length/height), aperture, and fracture permeability.

Determining a 3D fracture model may include determination of a deformation and geomechanics model (block 112). The 3D deformation model may be generated by performing a geomechanics numerical simulation using finite elements methods to capture the main episodes for paleo-stress tectonic deformation that could create most of the fractures observed at well level. These fractures may be modeled primarily with two processes: 1) folding fracture related and 2) faulting fracture related.

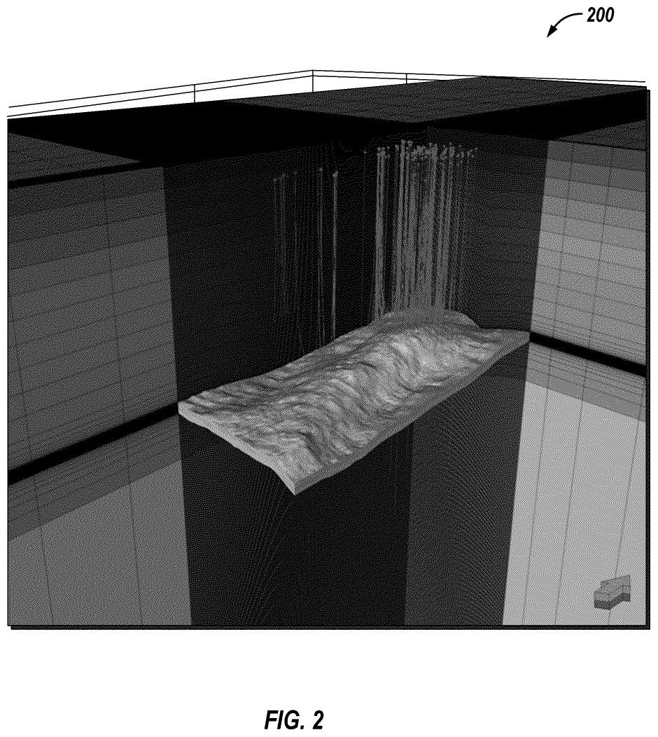

The in-situ stress regime may be modeled to capture the features for the mechanical properties, such as brittleness, geomechanical facies, and in-situ stress rotations and stress magnitude variation along the field. After modeling, a finite element geomechanical simulation may be performed to construct a 3D mechanical earth model. In some embodiments, the 3D mechanical earth model may be constructed using geomechanical simulation software such as VISAGE™ manufactured by Schlumberger Limited of Houston, Texas, USA. By way of example, FIG. 2 depicts the gridding of a 3D mechanical earth model 200 in accordance with an embodiment of the disclosure.

As shown in FIG. 1, the 3D fracture model may be constructed (block 114). The 3D fracture model may be constructed according to the techniques described in U.S. Pat. No. 10,607,043, issued Mar. 31, 2020, and titled “SUBSURFACE RESERVOIR MODEL WITH 3D NATURAL FRACTURES PREDICTION,” a copy of which is incorporated by reference in its entirety. The determination of the 3D fracture model may use inputs that include different reservoir parameters and properties obtained via different techniques and known earth science. Such inputs may include seismic attributes from seismic surveys,; rock and mechanical properties from geological modeling; measures from structural restoration models; core and well logs obtained from formation core samples and well logs performed in wellbores drilling into a reservoir; and reservoir engineering measures obtained from production measures and reservoir simulations of a reservoir layer.

Next, as shown in FIG. 1, the water saturation over time may be determined (block 104). Determining the water saturation over time may include obtaining pulsed neutron lifetime (PNL) logs and corresponding water saturation logs (block 116). The pulsed neutron lifetime (PNL) logs may be obtained from pulsed neutron (PN) logging operations that include inserting a pulsed neutron logging tool into a well (for example, a production well) accessing the naturally fractured subsurface reservoir. The pulsed neutron logging tool may include one or more detectors to measure gamma rays generated by absorption of neutrons produced by a neutron source in the surrounding reservoir. Obtaining PNL logs during a reservoir production stage may enable characterization of the water encroachment for the reservoir. The PNL measurements detect the changes in water saturation through the readings of chlorides content in the formation several times during the reservoir production.

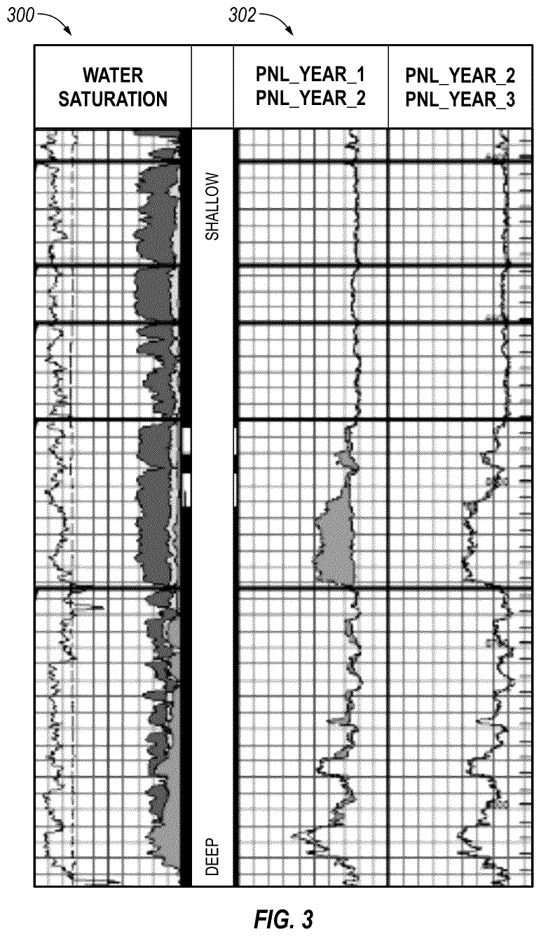

The acquisition of PNL logs may include consideration of the well space distribution to ensure representative samples of the water saturation measurements across the reservoir but also for entire reservoir section. FIG. 3 depicts a water saturation log 300 and PNL logs 302 over three time periods in accordance with an embodiment of the disclosure. The logs show the data collection and variation through time for the water saturation for selected wells in the reservoir.

As shown in FIG. 1, the process 100 also includes determining a fracture density index (block 106). The fracture density index represents natural fractures as a continuous property, accounting for the shape, geometry, and intensity of the natural fractures within a 3D grid-block model In some embodiments, the fracture density index is determined according to the techniques described in U.S. Publication No. 2023/0313649-A1, published Oct. 5, 2023, and titled “SYSTEM AND METHOD TO DEVELOP NATURALLY FRACTURED HYDROCARBON RESERVOIRS USING A FRACTURE DENSITY INDEX,” a copy of which is incorporated by reference in its entirety.

Determining the fracture density index may include performing a critical stress analysis (block 118) used to determine the fracture density index (block 120). The main fluid flow pathways may be discriminated from the 3D discrete fracture network (DFN) resulting from geomechanics and natural fracture prediction (NFP) modeling. The critically stressed fractures and fracture apertures estimation may be performed according to the techniques described in U.S. Publication No. 2023/0084141 A1, published Mar. 16, 2023, and titled “IDENTIFYING FLUID FLOW PATHS IN NATURALLY FRACTURED RESERVOIRS,” a copy of which is incorporated by reference in its entirety.

From the different fracture sets existing within the reservoir, only certain fractures will be optimally oriented under “in situ stress” for shearing and reactivation, and are thus hydraulically more conductive. Fracture aperture computed using a microresistivity technique confirms that fractures closer to failure by shear stress exhibit larger apertures and therefore, they are expected to have higher permeability. A discretized 3D fracture network may thus be produced that only contains fractures representing main fluid pathways in the reservoir.

The 3D critical stress analysis may include use of shear and normal stiffness stress for critically stressed fractures and fracture apertures determination. In terms of stress tensor components σ_{i,j} the normal stress may be defined as the product of stress vector multiplied by normal unit vector σₙ=T⁽ⁿ⁾.n and the magnitude of the shear stress (τₙ) component as defined in Equation 1:

$${τ}_{n} = \sqrt{{( {T}^{( n )} )}^{2} - {σ}_{n}} \qquad ( 1 )$$

A fluid flow path (that is, a critically stressed fracture) may be determined from shear stress and normal effective stress as shown in Equation 2:

$$Fluid flow path = ( τ - {σ}_{n} * Tan ( φ ) ) \geq 0 \qquad ( 2 )$$

In some embodiments, fluid flow paths for a fracture network in a rock matrix may be identified by using determined apertures combined with the normal effective stress and shear stress. The largest aperture corresponds to the greatest distance between the points and the failure Mohr Coulomb line (that is, the friction angle for non-intact rock). In some embodiments, apertures may be determined from microresistivity logs calibrated microresistivity arrays, the fracture dataset, shallow resistivity, and drilling mud resistivity. The fracture aperture determination may be performed using Equation 3:

$$W = {cAR}_{m}^{b} {R}_{xo}^{1 - b} \qquad ( 3 )$$

where W is the fracture width (that is, aperture), Rₓₒ is the flushed zone resistivity, Rₘ is the mud resistivity, and A is the excess current flowing into the rock matrix through the conductive media due to the presence of the fracture. The excess current is a function of the fracture width and may be determined from statistical and geometrical analysis of the anomaly it creates as compared to background conductivity. For example, the excess current may be determined by dividing by voltage and integrating along a line perpendicular to the fracture trace. The term c is a constant and b is numerically obtained tool-specific parameter (that is, specific to the resistivity tools). As will be appreciated, a greater fracture aperture (W) indicates a more open fracture that is likely to flow hydrocarbons or other fluids, and a lesser fracture aperture indicates a fracture that will likely have reduced or low flow to hydrocarbons or other fluids.

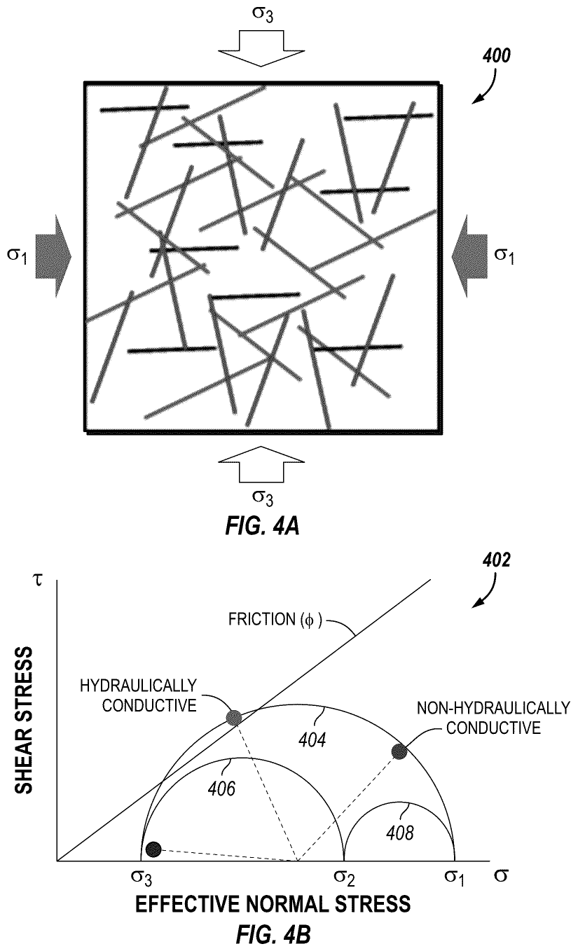

As will be appreciated, critical stress depends on the stress magnitude and the orientation of the fracture plane with respect to the in-situ stress orientation. The stress orientation affects the normal and shear stresses acting in the fracture plane. When normal and shear stress exceed the friction angle (for non-intact rock), the shearing may produce dilation that keeps the fracture hydraulically open. Fractures in this state may be referred to as “reactivated,” “critically stressed,” or as a “fluid flow path.” FIG. 4A is a diagram 400 illustrating fluid flow paths for hydraulically conductive and non-hydraulically conductive fractures using normal stresses (σ₁ and σ₃) in accordance with an embodiment of the disclosure. FIG. 4B is a plot 402 of shear stress vs normal stress and coefficient of friction in accordance with an embodiment of the disclosure. FIG. 4B illustrates “Mohr circles” 404, 406, and 408, as is known in the art.

Shear failure may be caused by two perpendicular stresses acting on the same plane, and is defined in conjunction with a Mohr circle by the following equation expressing stress conditions shown schematically in FIG. 4B:

$$σ {1}^{′} \geq C 0 + σ {3}^{′} tan 2 β \qquad ( 4 )$$

Where C0 is the unconfined compressive strength, σ1′ is the maximum effective stress, σ3′ is the minimum effective stress, and β is the angle between the normal stress and the maximum effective stress σ1′, such is β is determined as follows:

$$β = 45 ° + \frac{Φ}{2} \qquad ( 5 )$$

Where ϕ is the friction angle.

If the maximum effective stress σ1′ is exceeded, then the conditions for shear failure are satisfied.

The results of the critical stress analysis is a discretized 3D fracture network only including fractures that represent the main fluid pathways in the reservoir.

The fracture density index (FDI) represents critical stress fluid pathways in the region of interest. The fracture density index (FDI) determination may include converting the discrete fracture network (into two dimensional (2D) lines to compute a continuous fracture density property, such as described in U.S. Pat. No. 10,607,043, mentioned supra and incorporated by reference in its entirety. For example, various geographic information systems (GIS) geoprocessing software may have tools for computing line density. In some embodiments, the conversion of a 3D discrete fracture network to 2D lines may be performed by ArcGIS available from Environmental Systems Research Institute (Ersi), California, USA. In such embodiments, a raster map representing fracture density per area may be generated.

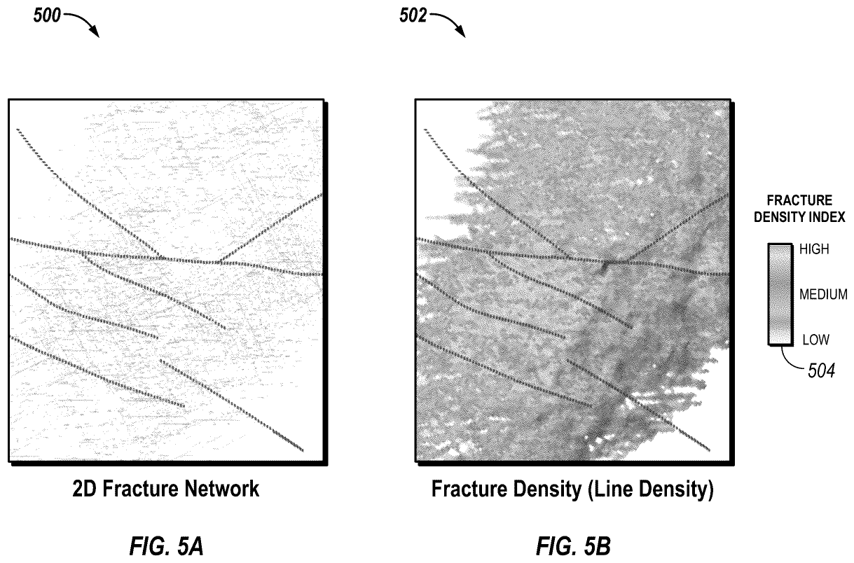

By way of example, FIG. 5A depicts a 2D fracture network 500 illustrating main fluid pathways in an area in accordance with an embodiment of the disclosure. FIG. 5B depicts a line density raster map 502 computed using the 2D fracture network of FIG. 5A as input in accordance with an embodiment of the disclosure. FIG. 5B also includes a legend 504 that indicates the fracture density index (FDI) according to color-coded values on a continuum from high to medium to low, enable visual identification of areas where natural fractures are more concentration.

As shown in FIG. 1, a time lapse saturation model may then be determined (block 108). Determining the time lapse saturation model (block 108) may include determining a cross-correlation fracture density index (FDI) vs water saturation (Sw) (block 122), determining a distribution model (block 124), and determining a water encroachment simulation (block 126).

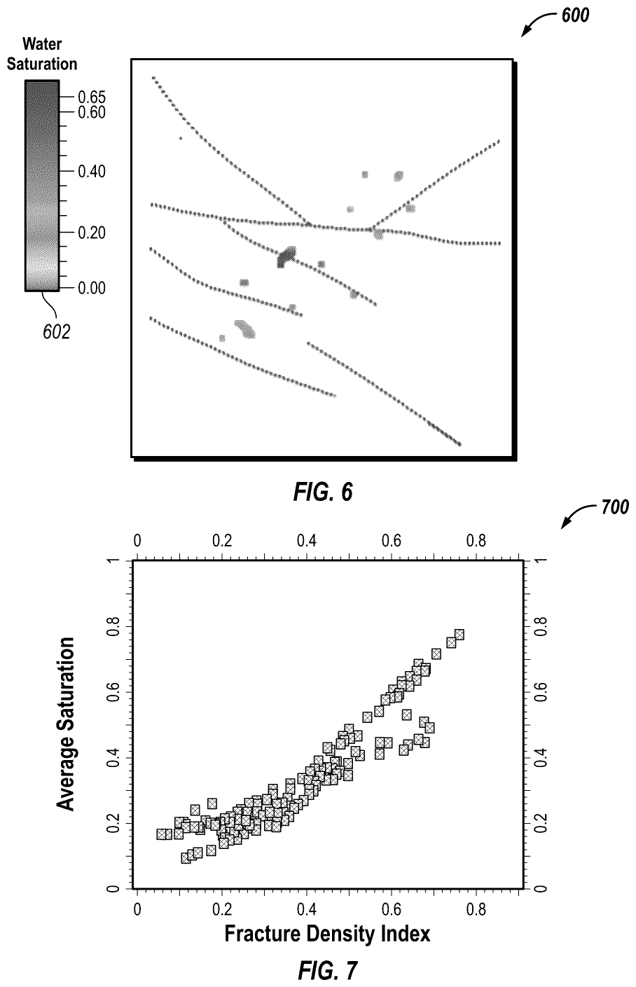

To determine the cross-correlation fracture density index (FDI) vs water saturation (Sw) (block 122), the PNL water saturation logs may be mapped onto the grid model including only the reservoir zones above the free water level. In some embodiments, this may be performed by calculating an average value representative for the well location at each specific time. By way of example, FIG. 6 depicts the average water saturations 600 from observed wells at a specific time in accordance with an embodiment of the disclosure. FIG. 6 also includes a legend 602 that indicates the water saturation according to color-coded values on a continuum from 0.00 to 0.70.

The water saturation values may then be compared to the fracture density index (FDI) using a normalized attribute on a scale of zero to one, where zero corresponds to a low fracture density index and one is a high fracture density index. FIG. 7 depicts a plot 700 of average saturation vs fracture density index (FDI) showing the cross-correlation between the saturation measured at a well point observation and the fracture density index (FDI) in accordance with an embodiment of the disclosure. The depicted correlation shown in FIG. 7 does not correspond to pre-production water saturation conditions, as at this condition the system should be in dynamic equilibrium.

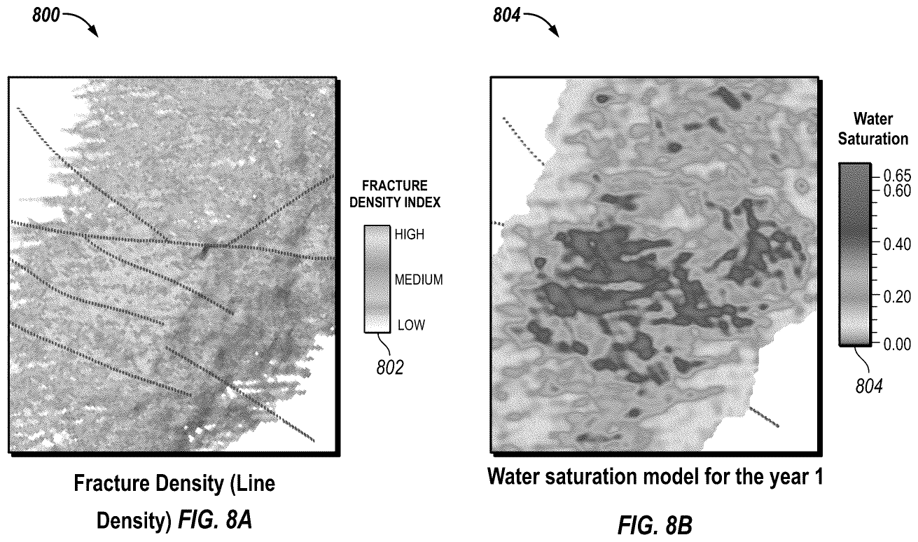

As shown in FIG. 1, determining the time lapse saturation model (block 108) may also include determining a distribution model (block 124). The saturation samples may be taken at any later time lapse state of production. Water saturation observations points may be extrapolated within the 3D grid model utilizing sequential Gaussian simulation (SGS). Saturation modelling is usually used for lateral flow dynamics; however, for fracture conductivity analysis embodiments of the disclosure use an approach for saturation modelling adapted by only focusing around the well region with very low weightage away from the well in 3D property distributions. This approach focuses on evidence-based saturation changes based on updated PNL logging and production logging tools (PLTs) and highlights localized areas where water saturation increases are observed. PNL, PLT and formation analysis log (FAL) saturations may be combined in a 3D saturation model and converted to a time-elapsed saturation model. By way of example, FIG. 8A depicts a fracture density (line density raster) map 802 in accordance with an embodiment of the disclosure. FIG. 8A also includes a legend 804 that indicates the fracture density index (FDI) according to color-coded values on a continuum from high to medium to low. FIG. 8B depicts a time-lapse water saturation model 806 on the same map in accordance with an embodiment of the disclosure. FIG. 8B also includes a legend 806 that indicates the water saturation according to color-coded values on a continuum from 0.00 to 0.70.

As shown in FIGS. 8A and 8B, most of the greatest saturation values correspond to the greatest fracture density index values, suggesting greater water saturation in wells located at the crestal area that also recorded greater water rates. This dynamic behavior is typical for reservoirs where natural fractures control reservoir productivity.

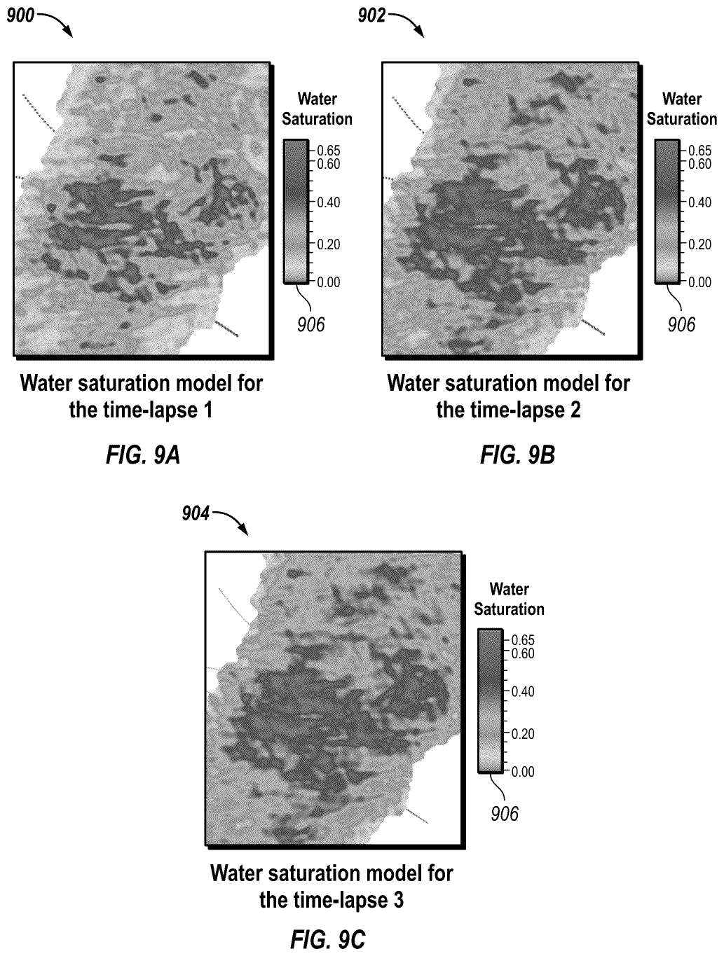

Additionally, as shown in FIG. 1, determining the time lapse saturation model (block 108) may also include performing a water encroachment simulation (block 124). A water encroachment simulation may be performed by repeating the distribution model for different time lapses during the reservoir production life, showing the evolution of water encroachment qualitatively through time. By way of example, FIGS. 9A-9C depict various water saturation models 900, 902, and 904 for different time lapses during reservoir production in accordance with an embodiment of the disclosure. FIGS. 9A-9C each include a legend 806 that indicates the water saturation according to color-coded values on a continuum from 0.00 to 0.70. Thus, FIG. 9A depicts a water saturation model 900 for a first time lapse, FIG. 9B depicts a water saturation model 904 for a second time lapse, and FIG. 9C depicts a water saturation model 906 for a third time lapse.

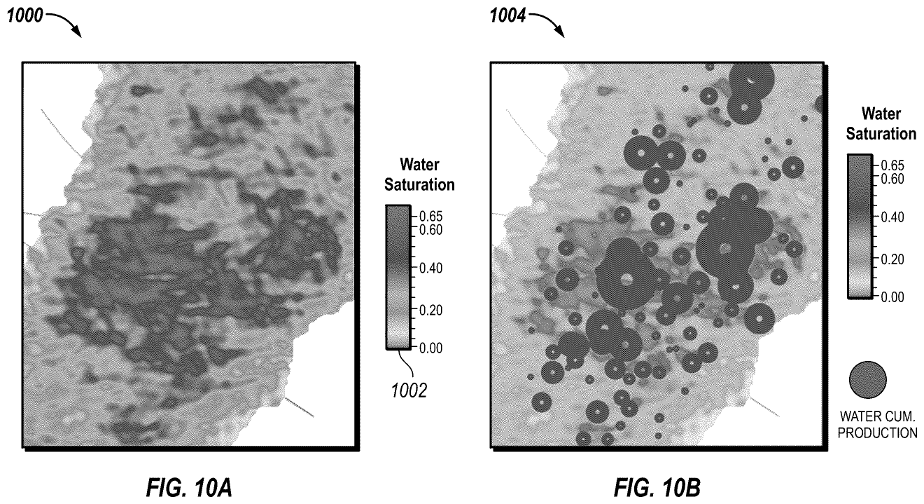

As shown in FIG. 1, the time lapse water saturation model may be calibrated and validated (block 110). In some embodiments, the model may be compared with a productivity index related to water production measurements (for example, a cumulative water and water cut ratio). The parameters may be correlated to a generated latest time lapse model to have a precise chronological comparison between the time lapse model and the water production indicator. By way of example, FIG. 10A depicts a water saturation model map 1000 for a first time lapse in accordance with an embodiment of the disclosure. FIG. 10 also includes a legend 1002 that indicates the water saturation according to color-coded values on a continuum from 0.00 to 0.70. FIG. 10B depicts cumulative water production 1004 (as indicated by blue circles) over the same time lapse mapped onto the water saturation model map 1000 in accordance with an embodiment of the disclosure. The diameter of each blue circle indicates the value of the cumulate water production for that location.

The time lapse water saturation model may be used in development of the naturally fractured subsurface reservoir, such as in production operations or well operations. For example, in some embodiments the time lapse water saturation model may be used to identify potential well location and well paths that minimize water production or encroachment for production of hydrocarbons. In such embodiments, a well may be drilled at an identified location and along an identified well path to avoid or minimize certain areas of water saturation that may affect well development or hydrocarbon production.

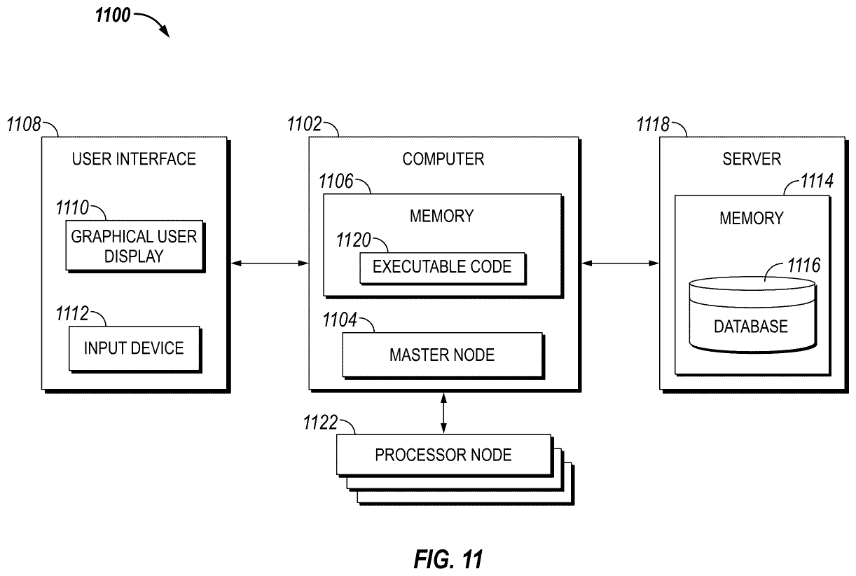

FIG. 11 depicts a data processing system 1100 that includes a computer 1102 having a master node processor 1104 and memory 1106 coupled to the processor 1104 to store operating instructions, control information and database records therein in accordance with an embodiment of the disclosure. The data processing system 1100 may be a multicore processor with nodes such as those from Intel Corporation or Advanced Micro Devices (AMD), or an HPC Linux cluster computer. The data processing system 1100 may also be a mainframe computer of any conventional type of suitable processing capacity such as those available from International Business Machines (IBM) of Armonk, N.Y., or other source. The data processing system 1100 may in cases also be a computer of any conventional type of suitable processing capacity, such as a personal computer, laptop computer, or any other suitable processing apparatus. It should thus be understood that a number of commercially available data processing systems and types of computers may be used for this purpose.

The computer 1102 is accessible to operators or users through user interface 1108 and are available for displaying output data or records of processing results obtained according to the present disclosure with an output graphic user display 1110. The output display 1110 includes components such as a printer and an output display screen capable of providing printed output information or visible displays in the form of graphs, data sheets, graphical images, data plots and the like as output records or images.

The user interface 1108 of computer 1102 also includes a suitable user input device or input/output control unit 1112 to provide a user access to control or access information and database records and operate the computer 1102. Data processing system 1100 further includes a database of data stored in computer memory, which may be internal memory 1106, or an external, networked, or non-networked memory as indicated at 1114 in an associated database 1116 in a server 1118.

The data processing system 1100 includes executable code 1120 stored in non-transitory memory 1106 of the computer 1102. The executable code 1120 according to the present disclosure is in the form of computer operable instructions causing the data processor 1104 to determine a deformation and geomechanics model, determine a fracture model, perform a critical stress analysis, determine a fracture density index (FDI), and analyze PNL and water saturation logs. Moreover, the computer operable instructions of the executable code 1120 may determine a time lapse water saturation model and control well operations such as drilling operations according to the techniques described herein.

It should be noted that executable code 1120 may be in the form of microcode, programs, routines, or symbolic computer operable languages capable of providing a specific set of ordered operations controlling the functioning of the data processing system 1100 and direct its operation. The instructions of executable code 1120 may be stored in memory 1106 of the data processing system 1100, or on computer diskette, magnetic tape, conventional hard disk drive, electronic read-only memory, optical storage device, or other appropriate data storage device having a non-transitory computer readable storage medium stored thereon. Executable code 1120 may also be contained on a data storage device such as server 1118 as a non-transitory computer readable storage medium, as shown.

The data processing system 1100 may be include a single CPU, or a computer cluster as shown in FIG. 11, including computer memory and other hardware to make it possible to manipulate data and obtain output data from input data. A cluster is a collection of computers, referred to as nodes, connected via a network. A cluster may have one or two head nodes or master nodes 1104 used to synchronize the activities of the other nodes, referred to as processing nodes 1122. The processing nodes 1122 each execute the same computer program and work independently on different segments of the grid which represents the reservoir.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for determining a time lapse water saturation in a naturally fractured subsurface reservoir, comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
determining a water saturation over time for a well accessing the subsurface reservoir; and
determining a time lapse water saturation model for the subsurface reservoir using the fracture density index and the water saturation over time.

2. The method of claim 1, wherein determining a water saturation over time for a well accessing the subsurface reservoir comprising obtaining a plurality of pulsed neutron lifetime (PNL) logs over a respective plurality of time periods and determining the water saturation from the plurality of PNL logs.

3. The method of claim 1, wherein determining a time lapse water saturation model for the subsurface reservoir using the fracture density index and the water saturation over time comprises correlating the water saturation over time with fracture density index (FDI).

4. The method of claim 1, wherein determining a time lapse water saturation model for the subsurface reservoir using the fracture density index and the water saturation over time comprises performing a sequential Gaussian simulation to extrapolate water saturation points within the discrete fracture network.

5. The method of claim 1, comprising validating the time lapse water saturation model by comparing the time lapse water saturation model with a water production measurement associated with the subsurface reservoir.

6. The method of claim 1, comprising:
identifying a location in the naturally fractured reservoir subsurface using the time lapse water saturation model; and
drilling a well in a subsurface geological structure at the location in the naturally subsurface fractured reservoir.

7. The method of claim 1, comprising obtaining a plurality of reservoir parameters representing a respectively plurality of properties of a primary naturally fractured reservoir, and determining a mechanical model using the obtained plurality of reservoir parameters.

8. A non-transitory computer-readable storage medium having executable code stored thereon for determining a time lapse water saturation in a naturally fractured subsurface reservoir, the executable code comprising a set of instructions that causes a processor to perform operations comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
determining a water saturation over time for a well accessing the subsurface reservoir; and
determining a time lapse water saturation model for the subsurface reservoir using the fracture density index and the water saturation over time.

9. The non-transitory computer-readable storage medium of claim 8, wherein determining a water saturation over time for a well accessing the subsurface reservoir comprising obtaining a plurality of pulsed neutron lifetime (PNL) logs over a respective plurality of time periods and determining the water saturation from the plurality of PNL logs.

10. The non-transitory computer-readable storage medium of claim 8, wherein determining a time lapse water saturation model for the subsurface reservoir using the fracture density index and the water saturation over time comprises correlating the water saturation over time with fracture density index (FDI).

11. The non-transitory computer-readable storage medium of claim 8, wherein determining a time lapse water saturation model for the subsurface reservoir using the fracture density index and the water saturation over time comprises performing a sequential Gaussian simulation to extrapolate water saturation points within the discrete fracture network.

12. The non-transitory computer-readable storage medium of claim 8, the operations comprising validating the time lapse water saturation model by comparing the time lapse water saturation model with a water production measurement associated with the subsurface reservoir.

13. The non-transitory computer-readable storage medium of claim 8, the operations comprising:
identifying a location in the naturally fractured reservoir subsurface using the time lapse water saturation model; and
controlling a drilling operation to drill a well in a subsurface geological structure at the location in the naturally subsurface fractured reservoir.

14. The non-transitory computer-readable storage medium of claim 8, the operations comprising obtaining a plurality of reservoir parameters representing a respectively plurality of properties of a primary naturally fractured reservoir, and determining a mechanical model using the obtained plurality of reservoir parameters.

15. A system for determining a time lapse water saturation in a naturally fractured subsurface reservoir, comprising:
a processor;
a non-transitory computer-readable memory accessible by the processor and having executable code stored thereon, the executable code comprising a set of instructions that causes the processor to perform operations comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
determining a water saturation over time for a well accessing the subsurface reservoir; and
determining a time lapse water saturation model for the subsurface reservoir using the fracture density index and the water saturation over time.

16. The system of claim 15, wherein determining a water saturation over time for a well accessing the subsurface reservoir comprising obtaining a plurality of pulsed neutron lifetime (PNL) logs over a respective plurality of time periods and determining the water saturation from the plurality of PNL logs.

17. The system of claim 15, wherein determining a time lapse water saturation model for the subsurface reservoir using the fracture density index and the water saturation over time comprises correlating the water saturation over time with fracture density index (FDI).

18. The system of claim 15, wherein determining a time lapse water saturation model for the subsurface reservoir using the fracture density index and the water saturation over time comprises performing a sequential Gaussian simulation to extrapolate water saturation points within the discrete fracture network.

19. The system of claim 15, the operations comprising validating the time lapse water saturation model by comparing the time lapse water saturation model with a water production measurement associated with the subsurface reservoir.

20. The system of claim 15, the operations comprising:
identifying a location in the naturally fractured reservoir subsurface using the time lapse water saturation model; and
controlling a drilling operation to drill a well in a subsurface geological structure at the location in the naturally subsurface fractured reservoir.
